(19) United States
(12) Patent Application Publication
(10) Pub. No.: US 2009/0191947 A1
(43) Pub. Date: Jul. 30, 2009

(54) GAMING SYSTEM AND A METHOD OF GAMING

(75) Inventors: Christopher Michael Stevens, Lane Cove, NSW (AU); Nicholas Luke Bennett, Manly Vale, NSW (AU); Philippa Alice Graham, Clovelly, NSW (AU)

Correspondence Address: MCANDREWS HELD & MALLOY, LTD, 500 WEST MADISON STREET, SUITE 3400, CHICAGO, IL, 60661, US

(73) Assignee: ARISTOCRAT TECHNOLOGIES AUSTRALIA PTY LIMITED, Lane Cove, NSW (AU)

(21) Appl. No.: 12/244,467

(22) Filed: Oct. 2, 2008

(30) Foreign Application Priority Data
Oct. 3, 2007 (AU) 2007905411

(51) Int. Cl. A63F 9/24; A63F 13/00

(52) U.S. Cl. 463/20; 463/30

(57) ABSTRACT

A gaming system comprising: a display; and a game controller arranged to: carry out a first game during which play of the first game is displayed as a first game display on the display; add at least a second game display to the display in response to a trigger event; and carry out a second game during which play of the second game is displayed on the second game display.

### RELATED APPLICATION

This application claims priority to Australian Provisional Patent Application No. 2007905411, having a filing date of Oct. 3, 2007, which is hereby incorporated by reference herein in its entirety.

### FIELD

The present invention relates to a gaming system, a method of gaming, a game controller and computer program code.

### BACKGROUND TO THE INVENTION

It is known to provide a gaming system such as a video slot machine wherein symbols are displayed as a plurality of virtual reels on a video display. Each reel comprises a plurality of symbols arranged in a predetermined sequence. Typically, when a reel stops, a plurality of symbols of each reel are visible on the display. For example, three symbols of each reel.

While such gaming systems provide users with enjoyment, a need exists for alternative gaming systems in order to maintain or increase player enjoyment.

### SUMMARY OF THE INVENTION

In a first aspect, the invention provides a gaming system comprising:

a display; and

a game controller arranged to:

carry out a first game during which play of the first game is displayed as a first game display on the display;

add at least a second game display to the display in response to a trigger event; and

carry out a second game during which play of the second game is displayed on the second game display.

In an embodiment, the game controller is arranged to modify the first game display when adding the at least a second game display.

In an embodiment, the game controller is arranged to carry out the first and second games concurrently after the second game display is added.

In an embodiment, the game controller is arranged to add the second game display and at least one further game display concurrently and to carry out each at least one further game on a respective one of each at least one further game display.

In an embodiment, the game controller is arranged to add a plurality of game displays such that at least one further game display is added subsequent to adding the second display and to carry out a game on each game display.

In an embodiment, the game controller is arranged to add each at least one further game display in response to a further trigger event.

In an embodiment, the trigger event starts a series of play rounds and a plurality of game displays are added during the series of play rounds.

In an embodiment, game displays are added after each of a plurality of successive play rounds of the series of play rounds.

In an embodiment, game displays are added until a limit is reached.

In an embodiment, the trigger event is one or more of:

an occurrence of a specific symbol or symbols;

a random occurrence related to turnover or time;

a machine event;

a trigger received from an external device;

a system event;

a condition initiated by an operator;

a decision by a player; or

an additional bet by a player.

In an embodiment, the game controller is arranged to remove the second game display from the display in response to an end event.

In an embodiment, each game is the same.

In an embodiment, each game is a spinning reel game and each game display displays spinning of the reels to a stop.

In an embodiment, the game controller determines whether to make an award in respect of each game.

In an embodiment, the game controller determines whether to make an award based on contemporaneous game play rounds of at least two games.

In an embodiment, the game controller determines whether to make an award based on displayed symbols of at least two games.

In an embodiment, the game controller comprises a game display controller arranged to add one or more game displays to the display.

In an embodiment, the gaming system comprises a memory and a processor arranged to implement the game controller by executing program instructions stored in the memory.

In an embodiment, the gaming system comprises a game play mechanism operable to initiate play of at least the first game.

In a second aspect, the invention provides a game controller for a gaming system, the game controller arranged to:

carry out a first game during which the game controller causes play of the first game to be displayed as a first game display on a display in data communication with the game controller;

cause at least a second game display to be added to the display in response to a trigger event; and

carry out a second game during which the game controller causes play of the second game to be displayed on the second game display.

In an embodiment, the game controller is arranged to modify the first game display when adding the at least a second game display.

In an embodiment, the game controller is arranged to carry out the first and second games concurrently after the second game display is added.

In an embodiment, the game controller is arranged to add the second game display and at least one further game display concurrently and to carry out each at least one further game on a respective one of each at least one further game display.

In an embodiment, the game controller is arranged to add a plurality of game displays such that at least one further game display is added subsequent to adding the second display and to carry out a game on each game display.

In an embodiment, the game controller is arranged to add each at least one further game display in response to a further trigger event.

In an embodiment, the trigger event starts a series of play rounds and a plurality of game displays are added during the series of play rounds.

In an embodiment, game displays are added after each of a plurality of successive play rounds of the series of play rounds.

In an embodiment, game displays are added until a limit is reached.

In an embodiment, the trigger event is one or more of:

an occurrence of a specific symbol or symbols;

a random occurrence related to turnover or time;

a machine event;

a trigger received from an external device;

a system event;

a condition initiated by an operator;

a decision by a player; or

an additional bet by a player.

In an embodiment, the game controller is arranged to remove the second game display from the display in response to an end event.

In an embodiment, each game is the same.

In an embodiment, each game is a spinning reel game and each game display displays spinning of the reels to a stop.

In an embodiment, the game controller determines whether to make an award in respect of each game.

In an embodiment, the game controller determines whether to make an award based on contemporaneous game play rounds of at least two games.

In an embodiment, the game controller determines whether to make an award based on displayed symbols of at least two games.

In an embodiment, the game controller comprises a game display controller arranged to add one or more game displays to the display.

In an embodiment, the game controller is implemented by a processor executing program instructions stored in the memory.

In a third aspect, the invention provides a:

carrying out a first game during which play of the first game is displayed as a first game display on a display;

adding at least a second game display to the display in response to a trigger event; and

carrying out a second game during which play of the second game is displayed on the second game display.

In an embodiment, the method comprises modifying the first game display when adding the at least a second game display.

In an embodiment, the method comprises carrying out the first and second games concurrently after the second game display is added.

In an embodiment, the method comprises adding the second game display and at least one further game display concurrently and to carry out each at least one further game on a respective one of each at least one further game display.

In an embodiment, the method comprises adding a plurality of game displays such that at least one further game display is added subsequent to adding the second display and to carry out a game on each game display.

In an embodiment, the method comprises adding each at least one further game display in response to a further trigger event.

In an embodiment, the trigger event starts a series of play rounds and a plurality of game displays are added during the series of play rounds.

In an embodiment, the method comprises adding game displays after each of a plurality of successive play rounds of the series of play rounds.

In an embodiment, the method comprises adding game displays until a limit is reached.

In an embodiment, the trigger event is one or more of:

an occurrence of a specific symbol or symbols;

a random occurrence related to turnover or time;

a machine event;

a trigger received from an external device;

a system event;

a condition initiated by an operator;

a decision by a player; or

an additional bet by a player.

In an embodiment, the method comprises removing the second game display from the display in response to an end event.

In an embodiment, each game is the same.

In an embodiment, each game is a spinning reel game and each game display displays spinning of the reels to a stop.

In an embodiment, the method comprises determining whether to make an award in respect of each game.

In an embodiment, the method comprises determining whether to make an award based on contemporaneous game play rounds of at least two games.

In an embodiment, the method comprises determining whether to make an award based on displayed symbols of at least two games.

In a fourth aspect, the invention provides computer program code which when executed implements the above methods.

In a fifth aspect, the invention provides a computer readable storage medium comprising the program code.

In a sixth aspect, the invention provides a data signal comprising the program code.

In a seventh aspect, the invention extends transmitting the computer program code.

### BRIEF DESCRIPTION OF THE DRAWINGS

An embodiment of the invention will now be described in relation to the following drawings in which:

FIG. 1 is a block diagram of the core components of a gaming system;

FIG. 2 is a perspective view of a gaming machine;

FIG. 3 is a block diagram of the functional components of a gaming machine;

FIG. 4 is a block diagram representing the structure of a memory;

FIG. 5 is a diagram schematic of a networked gaming system;

FIG. 6 is a further block diagram of the gaming system;

FIG. 7 is a flowchart of an embodiment;

FIGS. 8A and 8B are examples showing how the video display is modified by addition of a game display; and

FIGS. 9A to 9D are exemplary screen shots of an example.

### DETAILED DESCRIPTION

The embodiment provides a gaming system with a game controller arranged to dynamically generate at least one additional game in response to a trigger event occurring and to add a game display for the additional game to the video display of the gaming system so that at least two games are displayed. In a typical embodiment, both games are spinning reel games.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

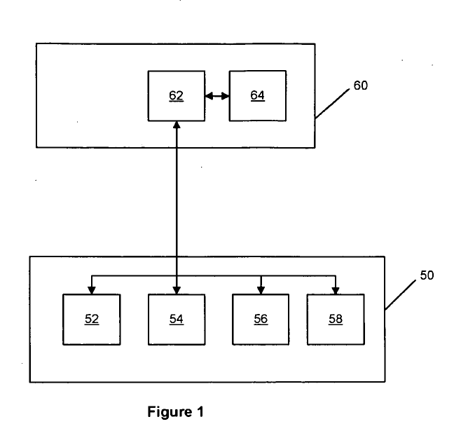

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54, a game play mechanism 56 that enables a player to input game play instructions, and a speaker 58 for outputting sound effects and the like.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

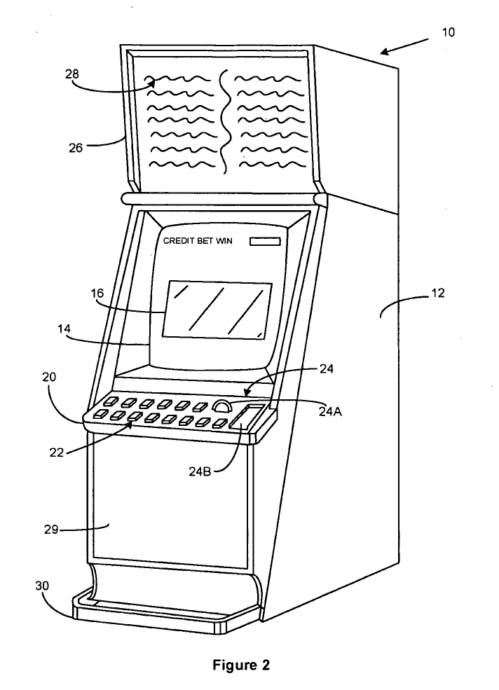

A gaming system in the form of a stand alone gaming machine 10 is illustrated in FIG. 2. The gaming machine 10 includes a console 12 having a video display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module may be provided having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit. The top box 26 may also include a display, for example a video display unit, which may be of the same type as the display 14, or of a different type.

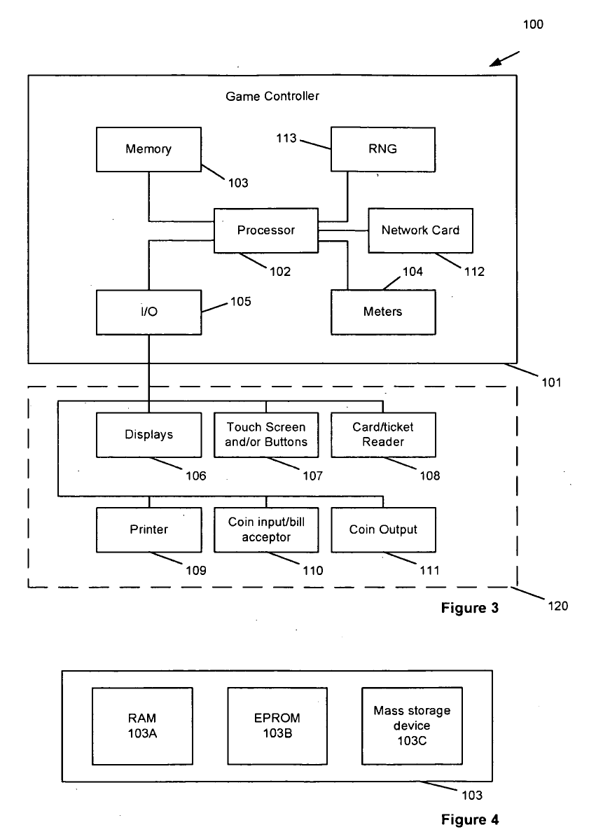

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 comprise one or more displays 106, buttons and/or a touch screen 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

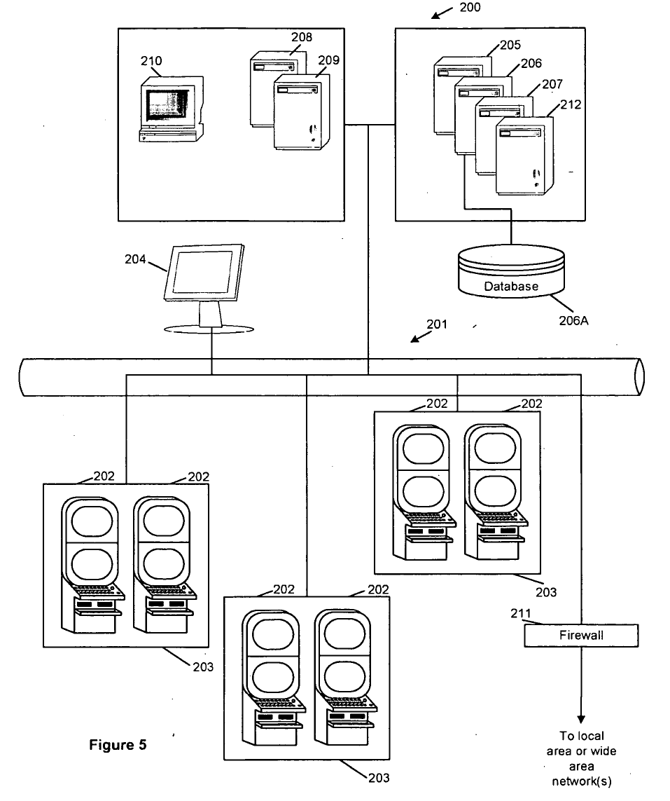

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to carry out the accounting in respect of the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games as required by the terminals.

### DETAILED DESCRIPTION

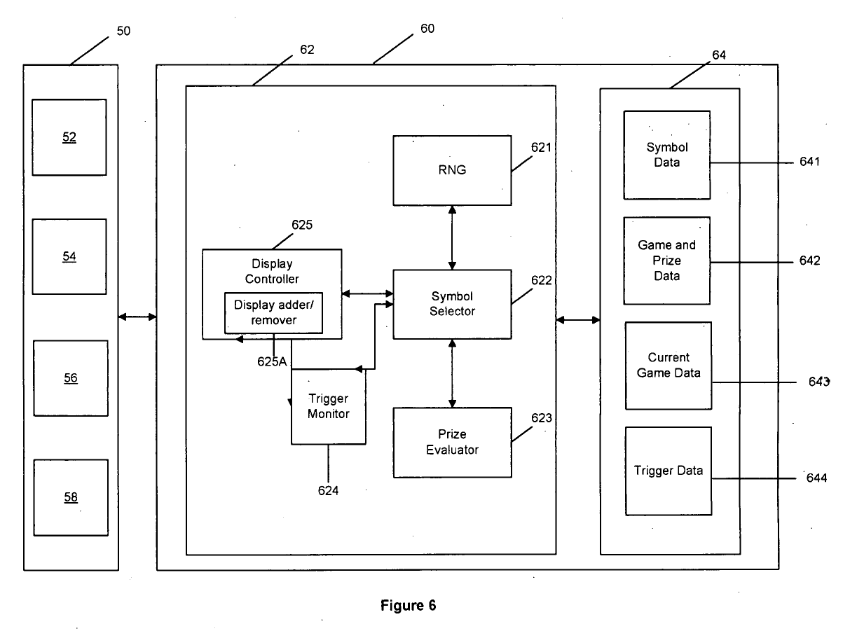

The game controller 60 of the embodiment is shown in more detail in FIG. 6. It will apparent that the processor 62 implements a number of modules, for example random number generator module 621 by executing software routines. Persons skilled in the art will appreciate that not all modules need be implemented by processor 62. For example, the random number generator module 621 could be implemented by a separate circuit or by a random number generator server.

The embodiment provides a spinning reel type game with a feature where additional spinning reels are added. Spinning reel type games typically allow a player to select how many win lines of a plurality of win lines they will play in each game—i.e. a minimum of one win line up to the maximum number of win lines allowed by the game. Persons, skilled in the art, will appreciate that in other embodiments, the player may select a number of reels to play or place a bet in some other manner. In most games, each win line is formed by a set of symbol positions consisting of one symbol position from each reel. That is, a symbol position within the display which corresponds to a reel is assigned to a win line. The symbol positions that constitute each of the win lines are usually advertised to the player by markings on the display or diagrams showing the symbol positions that correspond to each win line. A game outcome is determined based on the symbols on the win lines and a prize table that specifies awards. Many modern games have five reels and three symbols of each reel are displayed when the reels stop.

In the embodiment, symbol selector 622 of the game controller 60 selects symbols by employing a stop determining function that randomly determines the stop position for each reel based on symbol data 641. For example, if the symbol data specifies that there are five reels, each having twenty symbols in a designated symbol, the stop determining function might determine that the stop positions are positions: 3, 13, 7, 9 and 17. The spinning of the reels is then controlled so that each symbol designated by the stop position comes to a stop in the same row, typically a predetermined row in a “window” visible to the player on the display that corresponds to a player playing a single win line—e.g. the middle row. The other symbols that are visible in the display will be adjacent symbols in the symbol sequence—e.g. if the determined stop position is 3, then the symbols allocated to positions 2 and 4 will also be visible if three symbols of each reel are displayed.

In the embodiment, the game controller has a trigger monitor 624 which monitors game play to determine that a trigger event 644 has occurred and hence that a feature game should commence. When the feature commences, the display 54 is modified so that an additional spinning reel game is added to the display immediately. Herein, the displays of each game on display 54 are referred to as “game displays”.

In an alternative embodiment, the feature starts and when an additional trigger occurs, such as player pressing a button of input mechanism 56, the second game appears. That is, a first trigger starts the feature but it is not until a second trigger event occurs that a game is added.

Once the trigger monitor notes that a trigger event has occurred as specified in the trigger data 644 it advises the display controller 625 and the symbol selector 622. The display adder/remover 625a adds an additional game display, in this embodiment in the form of a second set of spinning reels to display 54. symbol selector 622 will then select a second set of symbols for a second game by determining an additional set of stop positions for the reel specified by symbol data using the random number generator in addition to the symbols selected for the first game. The trigger monitor 624 also records the number of current games as current game data 643.

In the embodiment the symbol selector 622 selects two sets of stop positions from the same reel data and the two games are displayed on display 54 at the same time by the display controller 625 In other embodiments, different reels could be used for each added game.

The player can now see two spinning reel games and is paid by prize evaluator 623 for outcomes on both games based on rule/prize data 643. The player can also be paid for combinations which are formed by symbols appealing on both games—e.g. two designated symbols in a first game plus two designated symbols in a second game may result in a prize such that a combined result is obtained across the games.

In the embodiment, when a further trigger event occurs, a further spinning reel game will be added to the screen—i.e. so that there can be three or more game displays. That is, each time the trigger event occurs, another spinning reel game will be added until the feature ends or a maximum number of games have been added to the screen.

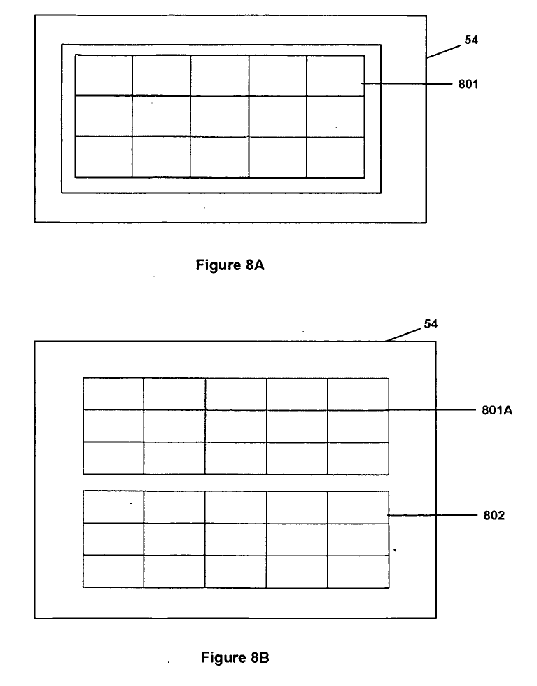

FIG. 8 shows a first display 54 where there is a first game display 801. Subsequent to the trigger condition occurring, a second display 802 is added to display 54 to display a second game. The first game display 801 is modified to produce a modified first game display 801A. Persons skilled in the art will appreciate that the display can be modified in a number of ways. In the example of FIG. 8b, the modification results in a change in the aspect ratio of the display 801. In other embodiments, the display may be modified in a manner which preserves the aspect ratio, while changing the size of the game display.

In an alternative embodiment, the feature starts a series of play rounds and with each play round in the series an additional game display is added to the display—i.e. no additional triggering is required. As indicated above, there may be a limit on the number of displays that are added and the feature may continue after the maximum number of game display have been added.

In an alternative embodiment, the feature starts and more than one game is added to the screen immediately.

In an embodiment, the games added to the screen have the same prize schedules and symbol distributions.

In an embodiment all games are played concurrently with the same bet and win line patterns purchased in the originating game. Alternatively, once a player enters the feature, all games play all lines at max bets. Alternatively, the bet and line patterns change.

Persons skilled in the art will also appreciate that rather than players selecting win lines to play, the player can select to play reels as is known in “Reel Power” type games produced by Aristocrat Leisure Industries Pty Ltd.

Depending on the embodiment, in the feature, the games can be free or purchased.

The feature can be triggered by any of the known methods including but not limited to:

the occurrence of specific symbols in the game;

a random occurrence related to turnover or time;

a machine event;

a trigger received from an external device;

a system event;

a condition initiated by an operator; or

a decision by a player.

The trigger to cause an additional game to be added to the display can be the same trigger or a different trigger including but not limited to:

the occurrence of specific symbols in the game;

a random occurrence related to turnover or time;

a machine event;

a trigger received from an external device;

a system event;

a condition initiated by an operator;

a decision by a player; or

additional bets by a player.

Eligibility for the feature can include the following:

always available;

available whenever a special symbol(s) appears in the window;

a player can choose to purchase the feature; or

a player can choose to purchase the feature subject to a threshold condition.

In an embodiment, the right to use the feature is purchased by the player prior to the commencement of the game.

In an embodiment, the right to use the feature is enabled once a threshold wager is reached.

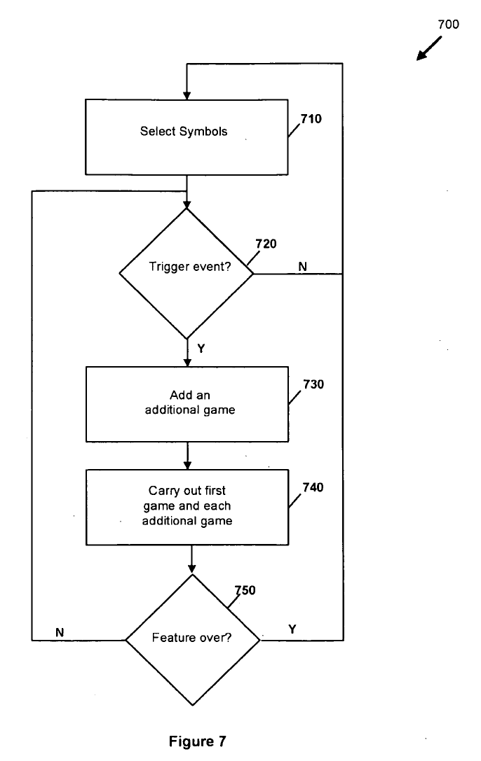

The method 700 of the embodiment is summarised in FIG. 7. The method begins by carrying out the first game 710 then it is determined whether a trigger event 720 has occurred which results in addition of an additional game 730. While a trigger condition does not occur, the method continues by carrying out the first game. After the additional game is added 730, the method involves carrying out the first game and each additional game concurrently until it is determined that the feature is over 750 at which point the method returns to carrying out the first game. In the embodiment, it is possible for additional trigger events to occur and/or further games to be added. Accordingly if the feature is not over, the game returns to monitoring a further trigger event 720.

Persons skilled in the art will appreciate that the feature can end in a number of ways known in the art including that a designated number of games has expired since the last display was added, a designated number of games has expired since the feature was originally triggered, a particular prize has been won, or a player chooses to end the feature. When the feature ends, display adder/remover 625a, removes each added game display. In embodiments where more than one game display is added, the added displays may be removed at different times. For example, a maximum number of game displays (e.g. 6) could be displayed when the feature triggers and a game display removed each time there is no win outcome.

Further aspects of the method will be apparent from the above description of the gaming system. Persons skilled in the art will also appreciate that the method could be embodied in program code. The program code could be supplied in a number of ways, for example on a computer readable medium, such as a disc or a memory (for example, that could replace part of memory 103) or as a data signal (for example, by downloading it from a server).

It will be understood to persons skilled in the art of the invention that many modifications may be made without departing from the spirit and scope of the invention, in particular it will be apparent that certain features of embodiments of the invention can be employed to form further embodiments.

### EXAMPLES

### Example 1

A video spinning reel game shows a 5 reel game with 3 symbols visible per reel. The player can place bets for lines and bets per line. Prizes are defined for collections of symbols on the game.

The game has a symbol depicting a “chilli”.

Whenever 3 “chilli” symbols appear anywhere in the window, the “chilli” feature commences. The “chilli” feature lasts for 10 games. The games are free.

When the “chilli” feature commences an additional 5*3 game is displayed on the screen. The player can now see two games on the screen.

The reels spin on both games and prizes are evaluated for each game.

Special prizes are also defined when a chilli symbol appears anywhere in the window in any game. E.g.—if game 1 shows 1 chilli, game 2 shows 2 chillies, a prize is paid for 3 chillies.

Whenever a total of 3 chillies appear anywhere in the window in all games another 5*3 game is added to the screen. The reels on all 3 games spin and prizes are evaluated for each game.

The feature concludes when 10 “chilli” feature games have been played.

### Example 2

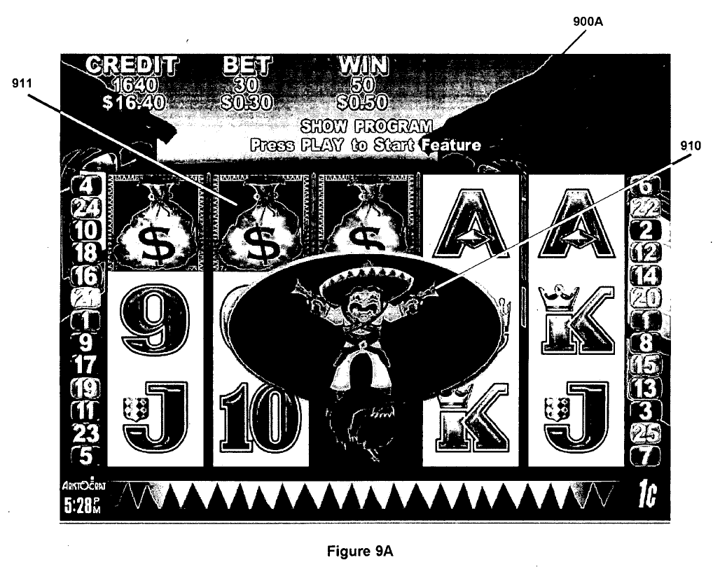

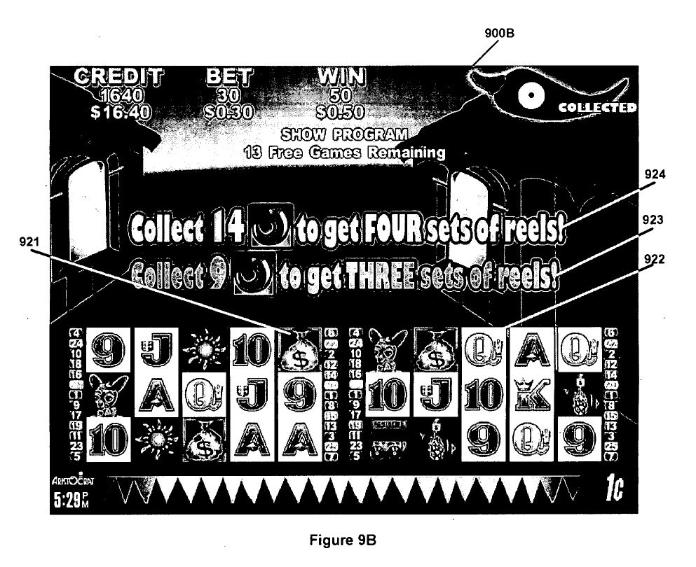

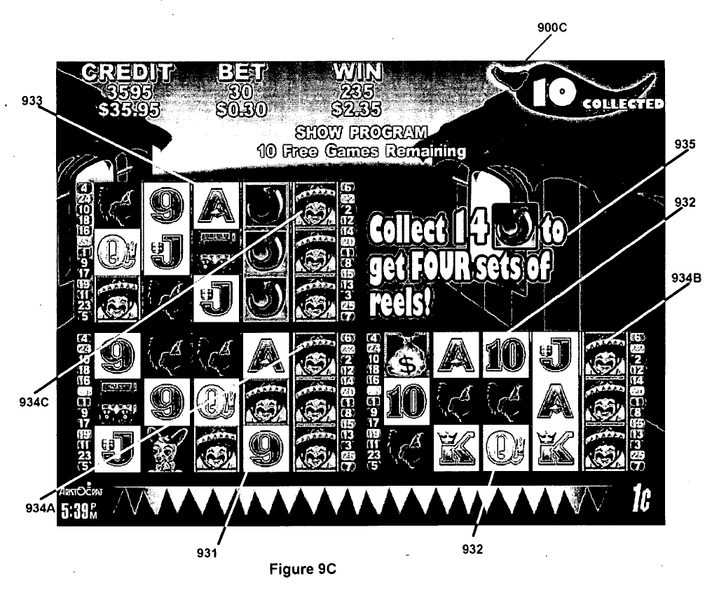

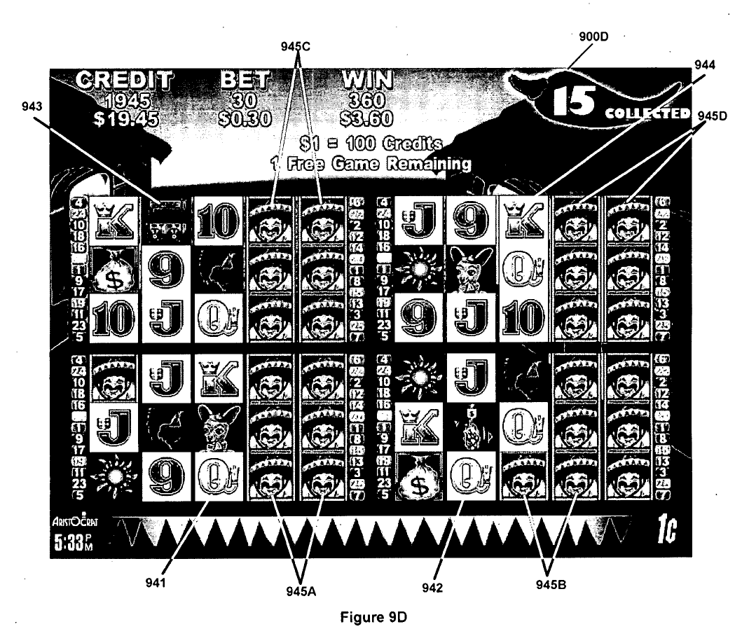

The screen shots 900 of FIGS. 9A to 9D show an example game where multiple game displays are added. FIG. 9A, shows a screen 900A where a shooting Mexican bandit character 910 superimposed on reels 911 to indicate that the wild chilli feature has been triggered. After the player presses play, the display changes to the screen 900B displayed in FIG. 9B so that there two game displays 921, 922. Messages 923,924 indicate that collecting nine and fourteen chillies will result in three and four sets of reels (game displays).

FIG. 3 shows a screen shot 900C, where a third game display has been added such that there are three game displays 931,932,933. Note also, that as an additional bonus, a wild reel 934 has been added to each of these game—i.e. a reel consisting solely of the Mexican bandit symbol which acts as a wild symbol substituting for all other symbols. A message 935 indicates that collecting fourteen chillies will add a further game display such that there a four sets of reels.

FIG. 4 shows a screen shot 900D, where a fourth game display has been added such that there are four sets of reels 941,942,943,944. Each reel set, includes a pair of wild reels 945.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A gaming system comprising:
a display; and
a game controller arranged to:
carry out a first game during which play of the first game is displayed as a first game display on the display;
add at least a second game display to the display in response to a trigger event; and
carry out a second game during which play of the second game is displayed on the second game display.

2. A gaming system as claimed in claim 1, wherein the game controller is arranged to modify the first game display when adding the at least a second game display.

3. A gaming system as claimed in claim 1, wherein the game controller is arranged to carry out the first and second games concurrently after the second game display is added.

4. A gaming system as claimed in claim 1, wherein the game controller is arranged to add the second game display and at least one further game display concurrently and to carry out each at least one further game on a respective one of each at least one further game display.

5. A gaming system as claimed in claim 1, wherein the game controller is arranged to add a plurality of game displays such that at least one further game display is added subsequent to adding the second display and to carry out a game on each game display.

6. A gaming system as claimed in claim 5 wherein the game controller is arranged to add each at least one further game display in response to a further trigger event.

7. A gaming system as claimed in claim 5, wherein the trigger event starts a series of play rounds and a plurality of game displays are added during the series of play rounds.

8. A gaming system as claimed in claim 7, wherein game displays are added after each of a plurality of successive play rounds of the series of play rounds.

9. A gaming system as claimed in claim 7, wherein game displays are added until a limit is reached.

10. A gaming system as claimed in claim 1, wherein the trigger event is one or more of:
an occurrence of a specific symbol or symbols;
a random occurrence related to turnover or time;
a machine event;
a trigger received from an external device;
a system event;
a condition initiated by an operator;
a decision by a player; or
an additional bet by a player.

11. A gaming system as claimed in claim 1, wherein the game controller is arranged to remove the second game display from the display in response to an end event.

12. A gaming system as claimed in claim 1, wherein each game is the same.

13. A gaming system as claimed in claim 12, wherein each game is a spinning reel game and each game display displays spinning of the reels to a stop.

14. A gaming system as claimed in claim 1, wherein the game controller determines whether to make an award in respect of each game.

15. A gaming system as claimed in claim 1, wherein the game controller determines whether to make an award based on contemporaneous game play rounds of at least two games.

16. A gaming system as claimed in claim 15, wherein the game controller determines whether to male an award based on displayed symbols of at least two games.

17. A gaming system as claimed in claim 1, wherein the game controller comprises a game display controller arranged to add one or more game displays to the display.

18. A gaming system as claimed in claim 1, comprising a memory and a processor arranged to implement the game controller by executing program instructions stored in the memory.

19. A gaming system as claimed in claim 1, comprising a game play mechanism operable to initiate play of at least the first game.

20. A game controller for a gaming system, the game controller arranged to:
carry out a first game during which the game controller causes play of the first game to be displayed as a first game display on a display in data communication with the game controller;
cause at least a second game display to be added to the display in response to a trigger event; and
carry out a second game during which the game controller causes play of the second game to be displayed on the second game display.

21. A game controller as claimed in claim 20, arranged to modify the first game display when adding the at least a second game display.

22. A game controller as claimed in claim 20, arranged to carry out the first and second games concurrently after the second game display is added.

23. A game controller as claimed in claim 20, arranged to add the second game display and at least one further game display concurrently and to carry out each at least one further game on a respective one of each at least one further game display.

24. A game controller as claimed in claim 20, arranged to add a plurality of game displays such that at least one further game display is added subsequent to adding the second display and to carry out a game on each game display.

25. A game controller as claimed in claim 24, arranged to add each at least one further game display in response to a further trigger event.

26. A game controller as claimed in claim 24, wherein the trigger event starts a series of play rounds and a plurality of game displays are added during the series of play rounds.

27. A game controller as claimed in claim 26, wherein game displays are added after each of a plurality of successive play rounds of the series of play rounds.

28. A game controller as claimed in claim 26, wherein game displays are added until a limit is reached.

29. A game controller as claimed in claim 20, wherein the trigger event is one or more of:
an occurrence of a specific symbol or symbols;
a random occurrence related to turnover or time;
a machine event;
a trigger received from an external device;
a system event;
a condition initiated by an operator;
a decision by a player; or
an additional bet by a player.

30. A game controller as claimed in claim 20, arranged to remove the second game display from the display in response to an end event.

31. A game controller as claimed in claim 20, wherein each game is the same.

32. A game controller as claimed in claim 31, wherein each game is a spinning reel game and each game display displays spinning of the reels to a stop.

33. A game controller as claimed in claim 20, wherein the game controller determines whether to make an award in respect of each game.

34. A game controller as claimed in claim 20, wherein the game controller determines whether to make an award based on contemporaneous game play rounds of at least two games.

35. A game controller as claimed in claim 34, wherein the game controller determines whether to make an award based on displayed symbols of at least two games.

36. A game controller as claimed in claim 20, comprising a game display controller arranged to add one or more game displays to the display.

37. A game controller as claimed in claim 20, implemented by a processor executing program instructions stored in the memory.

38. A method of gaming comprising:
carrying out a first game during which play of the first game is displayed as a first game display on a display;
adding at least a second game display to the display in response to a trigger event; and
carrying out a second game during which play of the second game is displayed on the second game display.

39. A method as claimed in claim 38, comprising modifying the first game display when adding the at least a second game display.

40. A method as claimed in claim 38, comprising carrying out the first and second games concurrently after the second game display is added.

41. A method as claimed in claim 38, comprising adding the second game display and at least one further game display concurrently and to carry out each at least one further game on a respective one of each at least one further game display.

42. A method as claimed in claim 38, comprising adding a plurality of game displays such that at least one further game display is added subsequent to adding the second display and to carry out a game on each game display.

43. A method as claimed in claim 42, comprising adding each at least one further game display in response to a further trigger event.

44. A method as claimed in claim 42, wherein the trigger event starts a series of play rounds and a plurality of game displays are added during the series of play rounds.

45. A method as claimed in claim 44, comprising adding game displays after each of a plurality of successive play rounds of the series of play rounds.

46. A method as claimed in claim 44, comprising adding game displays until a limit is reached.

47. A method as claimed in claim 40, wherein the trigger event is one or more of:
an occurrence of a specific symbol or symbols;
a random occurrence related to turnover or time;
a machine event;
a trigger received from an external device;
a system event;
a condition initiated by an operator;
a decision by a player; or
an additional bet by a player.

48. A method as claimed in claim 40, comprising removing the second game display from the display in response to an end event.

49. A method as claimed in claim 40, wherein each game is the same.

50. A method as claimed in claim 49, wherein each game is a spinning reel game and each game display displays spinning of the reels to a stop.

51. A method as claimed in claim 40, comprising determining whether to make an award in respect of each game.

52. A method as claimed in claim 40, comprising determining whether to make an award based on contemporaneous game play rounds of at least two games.

53. A method as claimed in claim 52, comprising determining whether to make an award based on displayed symbols of at least two games.

54. A method as claimed in claim 40, and further including a computer program code which when executed implements the method.

55. A method as claimed in claim 54 and further including a computer readable medium comprising said computer program.

56. A method as claimed in claim 54 and further including a data signal comprising said computer program code.

57. A method as claimed in claim 54 and further including transmitting the computer program code.
